(19) United States
(12) Patent Application Publication
(10) Pub. No.: US 2026/0077834 A1
(43) Pub. Date: Mar. 19, 2026

(54) BUOYANT OFFSHORE RENEWABLE ENERGY SYSTEM MOUNTING PLATFORM

(71) Applicant: MARINE POWER SYSTEMS LIMITED, Swansea South Wales (GB)

(72) Inventor: Graham FOSTER, Swansea South Wales (GB)

(73) Assignee: MARINE POWER SYSTEMS LIMITED, Swansea South Wales (GB)

(21) Appl. No.: 19/400,687

(22) Filed: Nov. 25, 2025

Related U.S. Application Data
(63) Continuation of application No. PCT/EP2024/064822, filed on May 29, 2024.

(30) Foreign Application Priority Data
May 30, 2023 (GB) 2308050.0

(51) Int. Cl. B63B 21/50; B63B 35/44; F03D 13/25

(52) U.S. Cl. CPC B63B 21/502; F03D 13/256; B63B 2035/442; B63B 2035/446; F05B 2240/95

(57) ABSTRACT

A buoyant offshore renewable energy system mounting having a buoyant spar and a plurality of mooring lines arranged to tether the spar to a bed of a body of water. The buoyant spar is positioned in the body of water at an operating depth. The plurality of mooring lines includes one or more first mooring lines affixed to the spar and arranged to engage the bed of the body of water. At least three further mooring lines are in communication with the spar between the top end and the bottom end, and a second end of each of the further mooring lines engage the bed of the body of water such that the further mooring lines are oriented diagonally at the operating depth. The first end of the spar is positioned above the surface, and the second end is positioned below the surface of the body of water.

### CROSS REFERENCE TO RELATED APPLICATIONS

This continuation application claims priority benefit from International Application No. PCT/EP2024/064822 filed on May 29, 2024, which claimed priority from Great Britain Application No. 2308050.0 filed May 30, 2023, which are both incorporated herein by reference in their entirety.

### FIELD OF THE INVENTION

The present disclosure relates to a buoyant offshore platform for supporting offshore renewable energy systems such as wind turbines.

### BACKGROUND OF THE INVENTION

Offshore wind energy and wave energy have both been identified as leading technology options to decarbonise the global energy system. The economic viability and practical feasibility of these renewable energy systems are heavily reliant on the ease and cost of installation and maintenance of these systems offshore. One solution to minimise the costs of these systems is to install the wave energy and wind energy systems offshore on floating or buoyant platforms.

Buoyant offshore platforms are beneficial in that the foundations required for a buoyant offshore platform are typically quicker and easy to install on the bed of the body of water, and the foundations can be more easily laid at greater depths. Furthermore, a complete buoyant offshore platform may be manufactured on or adjacent to land and can then be towed out to the desired location rather than assembled offshore piece-by-piece. However, problems exist with current state-of-the-art buoyant offshore platforms and with the methods and equipment used to assemble and install the platforms offshore. It is therefore desirable to provide an offshore renewable energy system mounting platform which overcomes these issues with the state-of-the-art.

### SUMMARY OF THE INVENTION

The present disclosure is directed to a buoyant platform intended for supporting a renewable energy system, preferably a wind turbine, in a body of water. In particular, the platform comprises a single buoyant structural element arranged to be partially submerged in a body of water to an operating depth by any suitable means. A first end of the structural element comprises a surface arranged to support a renewable energy system, preferably a wind turbine, above the surface of the body of water when the structural element is partially submerged to the operating depth. To maintain the structural element at the operating depth, the platform further comprises one or more first mooring lines for tethering the bottom end of the structural element to a bed of the body of water. A plurality of further angled mooring lines are arranged to tether one or more sides of the structural element to the bed of the body of water.

Preferably, the one or more first mooring lines may be arranged to engage the bed of the body of water at a location vertically below the bottom end such that the first mooring line is substantially coaxial with the spar at the operating depth, and/or the one or more first mooring lines may include at least two (preferably three) first mooring lines being arranged to engage the bed of the body of water such that the at least two first mooring lines are oriented diagonally relative to the structural element at the operating depth.

Preferably, the structural element is a buoyant elongate spar, or the structural element is a buoyant spar having a first cylindrical section with a first predetermined diameter, a second cylindrical section with a second predetermined diameter, wherein the second predetermined diameter is smaller than the first predetermined diameter, and a tapered section between the first cylindrical section and the second cylindrical section forming a single structural element, and may be referred to as a bottle-shaped structural element.

Preferably the attachment points on the structural element of the further angled mooring lines are distanced from the attachment point of the one or more first mooring lines. At the operating depth, the buoyancy of the structural element provides a tension to the one or more first mooring lines and the further angled mooring lines. The buoyancy of the structural element is also arranged to support the mass of the renewable energy system supported thereon. The net buoyancy of the structural element while supporting the renewable energy system in the body of water is therefore positive such that a tension is applied to the mooring lines. The tension in the mooring lines, together with the combination of vertical and/or angled lines that have fixation points on the structural element that are distanced from each other, and the positioning of anchor points of the mooring lines on the bed of the body of water, preferably provides a robustness to the structural element against dynamic wind and wave forces acting on the platform in use. As such the structural element is constrained against vertical motions (heave), sideways motions (surge) and tilting motions and is therefore able to remain substantially stationary in a variety of wind and wave conditions, with this stationary nature being useful in maintaining optimal operating efficiency of renewable energy capture and conversion by the renewable energy system supported atop the structural element, and also permitting more straightforward access to the structural element for maintenance of the renewable energy system.

The use of a single elongate or single bottle-shaped structural element to support a renewable energy system above a surface of a body of water in this manner maximises ease of manufacture and deployment while minimising resource usage for the manufacture of renewable energy system mounting platforms. The nature of the elongate or bottle-shaped structural element provides a minimal surface area acting against wave and wind forces, thereby minimising drag against wave and wind forces and currents acting thereon, and as such minimising movement of the platform in the body of water in a variety of weather conditions and sea states. Supporting the renewable energy system on the single structural element preferably additionally maximises ease of access to the platform and the renewable energy system by marine vessels for deployment and maintenance, without requiring the traversal of a complicated structure and minimising risk of damage to the platform or renewable energy system. The use of a single elongate or single bottle-shaped structural element for the platform additionally means that in the event of damage, the platform may be replaced with ease and with minimal resources.

In most preferable embodiments, the top end of the buoyant single structural element, when supporting the renewable energy system at the operating depth, protrudes through the surface of the body of water such that, at the operating depth, the platform is arranged to maintain the renewable energy system above the surface of the body of water. As such, the renewable energy system is protected from the effects of sea water exposure, or from the effects of variable wave forces, on the system.

The fixation points of the further mooring lines on the structural element in some preferable embodiments may be positioned proximate the top end of the structural member for maximum stability of the platform in use. In some embodiments this positioning may not be suitable and may risk collision of the mooring lines with a marine vessel during deployment or maintenance. In such embodiments the fixation points of the further mooring lines on the structural element may be additionally protected from collision by a guard member having an impact absorbing surface positioned above the fixation points. The impact absorbing surface may be distanced from the main body of the structural element to minimise risk of collision of marine vessels with the structural element. Risk of collision with the mooring lines may be minimised, or further minimised, by positioning the fixation points such that they are located beneath the surface of the body of water when the platform is at the operating depth. The lower placement of the fixation points preferably reduces the required distance between the vessel and the platform during maintenance, with the vessel being able to approach the platform closer with reduced risk of collision with the mooring lines. Positioning of the fixation points lower on the body of the structural element in this manner may, in some embodiments, compromise stability of the structural member in various weather conditions and sea states. Outrigging may be used in such embodiments to support a mooring line fixation point distanced from main body of the structural element, the outrigging preferably providing the equivalent of a higher mooring line fixation point on the structural element, thereby preferably overcoming the reduction in stability that may be associated with lowering the mooring line fixation point relative to the structural element.

In some embodiments, a single outrigging may be used to provide a common mooring line fixation point for each of the further mooring lines. Such embodiments would maximise the surface area of the structural element which was free from fixings and thereby maximise access to the structural element and the renewable energy system supported thereon by marine vessels. Such embodiments may be suitable in installations where the platform is expected to face wind and/or waves in largely only a single direction. In other embodiments, multiple outrigging members may be used, for example one per further mooring line. In such embodiments, the outrigging members are preferably spaced about the peripheral surface area of the structural element to provide a marine vessel access portion of the structural element, the marine vessel access portion being free from mooring line fixation points or outrigging and therefore minimising risk of collision with marine vessels during deployment and ongoing maintenance.

In some embodiments, one or more of the further mooring lines preferably include a protection member, the protection member extending from the first end of the further mooring lines for a predetermined distance along the further mooring lines. In some embodiments, the protection member may be either: an outer layer surrounding the further mooring line; or a substantially solid member to which the further mooring line is attached.

Therefore, in accordance with an aspect of the present disclosure, there is provided a buoyant offshore renewable energy system mounting platform, the platform comprising: a buoyant spar having a top end and a bottom end, the spar arranged to support a renewable energy system thereon; and a plurality of mooring lines arranged to tether the spar to a bed of a body of water such that the spar is positioned in the body of water at an operating depth, the plurality of mooring lines comprising: one or more first mooring lines affixed to a bottom end of the spar, the bottom end distal to the top end, and arranged to engage the bed of the body of water; and at least three further mooring lines, a first end of each of the further mooring lines being in communication with the spar between the top end and the bottom end thereof, and a second end of each further mooring line being arranged to engage the bed of the body of water such that said further mooring line is oriented diagonally relative to the spar at the operating depth; wherein at the operating depth, the first end of the spar is positioned above a surface of the body of water and the second end is positioned below the surface of the body of water.

In some embodiments, the one or more first mooring lines may be arranged to engage the bed of the body of water at a location vertically below the bottom end such that the first mooring line is substantially coaxial with the spar at the operating depth. In some embodiments, the one or more first mooring lines may include at least two (preferably three) first mooring lines being arranged to engage the bed of the body of water such that the at least two first mooring lines are oriented diagonally relative to the spar at the operating depth.

In some embodiments, the spar may be a buoyant elongate spar. In some embodiments, the spar may be a buoyant spar having a first cylindrical section with a first predetermined diameter, a second cylindrical section with a second predetermined diameter, wherein the second predetermined diameter is smaller than the first predetermined diameter, and a tapered section between the first cylindrical section and the second cylindrical section.

In preferable embodiments, a non-zero vertical spacing is defined between a mooring line fixation point of the first mooring line on the spar, and each of a respective mooring line fixation point of the further mooring lines. Preferably the mooring line fixation points of the further diagonal mooring lines are vertically distanced from the mooring line fixation point of the first (coaxial) mooring line to constrain the spar in the tilt degree of freedom. If the mooring line fixation points of the further diagonal mooring lines are not vertically distanced from the mooring line fixation point of the first (coaxial) mooring line, the spar may not be stable in tilt (the spar may be able to rotate about the mooring line fixation point). The greater said vertical spacing, preferably the more stable the spar will be for a given buoyancy.

In some preferable embodiments, the further mooring lines are each affixed to the spar at a respective location; and wherein at the operating depth, either: each said respective location is above the surface of the body of water; or each said respective location is below the surface of the body of water.

In some embodiments, the spar preferably further comprises a guard member, the guard member having an impact absorbing surface positioned at a guard member location located along a side wall of the spar between the top end and the bottom end. In some preferable embodiments, the impact absorbing surface is supported at a non-zero distance from the side wall of the spar. In some embodiments, the guard member preferably extends at least partially about the periphery of the spar at the guard member location. In some embodiments, the guard member is preferably substantially toroidal, or a segmented toroid in shape.

In some preferable embodiments, the guard member location is located at or above said respective locations. As such, the guard member may act to prevent collision of marine vessels with the mooring line fixation points.

In some preferable embodiments the platform further comprises an outrigger member affixed to, and projecting outwardly from, an outrigger member location located along a side wall of the spar between the top end and the bottom end; wherein the outrigger member comprises a mooring line fixation point located on a portion of the outrigger member distal to the spar; and wherein the first end of at least one of the further mooring lines is affixed to the mooring line fixation point.

In some preferable embodiments, the first end of each of the further mooring lines is preferably affixed to the mooring line fixation point. In such embodiments, each of the further mooring lines shares a common fixation point on the spar by virtue of a single outrigger member.

In some preferable embodiments, the platform comprises a corresponding said outrigger member for each of the further mooring lines, the first end of each said further mooring line being affixed to the mooring line fixation point of the corresponding outrigger member. In such embodiments, each of the further mooring lines is affixed to the spar at a common fixation point by way of a corresponding outrigger member.

The outrigger member is preferably arranged to support the mooring line fixation point at a non-zero distance from the spar. In some preferable embodiments, the outrigger member comprises: a lateral brace extending between a first point along a side wall of the spar and the mooring line fixation point in a direction substantially perpendicular to the spar; and a diagonal brace extending between a second point along the side wall of the spar and the mooring line fixation point, the second point higher than the first point. The diagonal support provided to the mooring line fixation point by way of the diagonal brace of the outrigger member, with an end thereof affixed to the side wall of the spar at a higher point than that of the lateral brace, preferably equates to a higher mooring line fixation point of the corresponding mooring line(s). The greater stability which may be afforded by a higher mooring line fixation point is thereby afforded while minimising risk of collisions of the mooring line with a marine vessel by positioning the actual mooring line fixation point lower relative to the spar, and preferably below the surface of the body of water when the spar is positioned at the operating depth.

At the operating depth, the further mooring lines are preferably each oriented diagonally relative to the spar along a corresponding axis, wherein said corresponding axes do not intersect.

In embodiments comprising an outrigger member, at the operating depth, the mooring line fixation point is positioned beneath the surface of the body of water. The outrigger member preferably therefore permits a lower positioning of the mooring line fixation point relative to the spar, while maintaining stability of the top portion of the spar when supporting a renewable energy system or device thereon.

The second end of each of the further mooring lines is preferably tethered to a corresponding anchor point on the bed of the body of water, each said anchor point spaced to form vertices of a triangle on the bed of the body of water. In some preferable embodiments, the triangle is an equilateral triangle. The spar may be positioned substantially at the centre of the triangle. The regular spacing of the anchor points relative to the spar in such preferable embodiments may aim to provide the same support against wind and wave forces in all directions and may be preferable for platforms intending to support renewable energy devices, such as a wind turbine, which may be multidirectional, or which have an adjustable direction to account for varying wind directions. In some preferable embodiments, the triangle is an isosceles triangle. The offset nature of the positioning of the apex of the isosceles triangle relative to the base vertices of the isosceles triangle may be beneficial to provide more support in a single direction, and may therefore be preferable for renewable energy devices, such as wind turbines, intended to account for wind incident on the turbine primarily in a single direction.

It will be appreciated that any suitable number of further mooring lines greater than three may be used, and that irrespective of number, the mooring line fixation points of the further mooring lines are preferably angularly equi-spaced around the spar.

In preferable embodiments, the spar comprises a vessel access portion, the vessel access portion being a portion of a side wall of the spar free of outrigger members or mooring line fixation points. The vessel access portion may, for example, be a surface area of the spar which is free of outrigger members or mooring line fixation points, thereby providing minimal hindrance to the approach of a marine vessel for the purpose of deployment or maintenance of the platform or renewable energy system or device mounted thereon. The vessel access portion may, in some embodiments, extend along the length of the side wall of the spar. The vessel access portion may in such embodiments have a constant width along the entire length of the spar. The vessel access portion may, in some embodiments, be portion of a side wall of the spar defined between two said mooring line fixation points or outrigger members. In some embodiments, the two said mooring line fixation points or outrigger members subtend an angle of at least 120° at a centre of the spar. Subtending an angle of at least 120° at the centre of the spar will be understood to mean that two lines intersecting at the centre of the spar, when drawn from locations of each of the two mooring line fixation points or outrigger members on an outer surface of the spar, form an angle therebetween of at least 120°. The vessel access portion may, for example, extend about at least 33 % of the peripheral edge or circumference of the spar.

In some embodiments, the platform further comprises a walkway extending from or in communication with the spar and positioned at least partially within the vessel access portion, the walkway arranged to remain above the surface of the body of water when the platform is at the operating depth. The walkway preferably enables maintenance personnel to disembark a marine vessel onto the platform for the purpose of maintenance of the platform or the renewable energy system. The walkway preferably enables a vessel clearance, the vessel clearance being a distance from the spar that a marine vessel may be located wherein said maintenance personnel may disembark therefrom onto the walkway. The vessel clearance distance can be any suitable distance and is preferably at least 10 metres. In some embodiments, the vessel may preferably be positioned side-on to the platform during maintenance. The walkway may, in some embodiments, be arranged to engage a separate vessel walkway extending from a said marine vessel, in order to maximise the vessel clearance during maintenance.

At the operating depth, a buoyancy of the spar is preferably arranged to apply a tension to the first mooring line and the further mooring lines; said buoyancy being further arranged to support a mass of said renewable energy system such that the renewable energy system is maintained above a bed of the body of water. The net buoyancy of the spar while supporting the renewable energy system thereon is therefore preferably positive such a tension is applied to the mooring lines.

In most preferable embodiments, the spar is substantially cylindrical. In some embodiments, the cylinder may be tapered proximate the top end such that the diameter of the top end is smaller than the diameter of the bottom end. In such embodiments, the cylindrical body of the spar may comprise a first portion extending from the bottom end of the spar to an intermediary point along the spar proximate the top end thereof, the first portion having a constant diameter; and a second portion extending between the intermediary point and the top end of the spar, the diameter of the second portion at the top end of the spar being lower than the diameter of the second portion at the intermediary point.

A platform as claimed in any one of the preceding claims, wherein the renewable energy system is a wind turbine. Embodiments will be appreciated wherein the renewable energy system is any suitable renewable energy system or device intended for capturing, converting or storing renewable energy forms, such as wind or wave energy, to useful energy.

In embodiments wherein the renewable energy system comprises a wind turbine, the top end of the spar is arranged to support the wind turbine such that a mast thereof is substantially coaxial with the spar.

The renewable energy system is supported on an uppermost surface of the elongate spar which is preferably positioned in a plane such that when the platform is at the operating depth, said surface is maintained above the surface of the body of water.

In some preferable embodiments, the spar preferably comprises one or more landing features arranged to engage with corresponding connecting means of a marine vessel. The accessibility of the spar and any renewable energy system mounted thereon, which may in some embodiments be afforded by a vessel access portion, may be supplemented in some embodiments by landing features arranged to aid connecting of a marine vessel to the platform. Such landing features may be any suitable landing features, and preferably complement a corresponding connecting mechanism of a marine vessel.

In some preferable embodiments, the operating depth may be adjustable. The operating depth may be adjustable by retracting, extending or otherwise applying or releasing a tensioning force to each of the one or more mooring lines using any suitable means. Control of the operating depth in this manner may for example be in response to changing sea states, and may permit maintaining the top end of the spar protruding through the surface of the body of water such that the renewable energy system is maintained above the surface of the body of water in any sea state.

In some embodiments, one or more of the further mooring lines preferably include a protection member, the protection member extending from the first end of the further mooring lines for a predetermined distance along the further mooring lines. In some embodiments, the protection member is preferably either: an outer layer surrounding the further mooring line, or a substantially solid member to which the respective further mooring line is attached. The protection member may be added to one or more of the further mooring lines between the platform and a predetermined distance therefrom, wherein the predetermined distance is based on a calculated depth below the mean waterline of the body of water. The protection member may be an armoured outer layer applied to the further mooring line or be a solid section to which the further mooring line is attached. As such, the protection member may act to prevent damage to the further mooring lines, for example, through impacts with floating marine debris or accidental vessel contact.

It will be appreciated that any features described herein as being suitable for incorporation into one or more aspects or embodiments of the present disclosure are intended to be generalizable across any and all aspects and embodiments of the present disclosure. Other aspects of the present disclosure can be understood by those skilled in the art in light of the description, the claims, and the drawings of the present disclosure. The foregoing general description and the following detailed description are exemplary and explanatory only and are not restrictive of the claims.

### BRIEF DESCRIPTION OF THE DRAWINGS

The accompanying drawings, which are incorporated in and constitute a part of the specification, illustrate embodiments of the disclosure and together with the detailed description herein, serve to explain the principles of the disclosure. It is emphasized that, in accordance with the standard practice in the industry, various features are not drawn to scale. In fact, the dimensions of the various features may be arbitrarily increased or reduced for clarity of discussion. The drawings are only for purposes of illustrating preferred embodiments and are not to be construed as limiting the disclosure:

FIG. 1A provides a perspective view of an example embodiment of a platform in accordance with an aspect tethered to a bed of a body of water at an operating depth, in accordance with an aspect of the present disclosure;

FIG. 1B and FIG. 1C provide alternate side views of the platform of FIG. 1A, in accordance with an aspect of the present disclosure;

FIG. 1D provides a plan view of the platform of FIG. 1A, in accordance with an aspect of the present disclosure;

FIG. 2A provides a perspective view of an alternate example embodiment of a platform in accordance with an aspect tethered to a bed of a body of water at an operating depth, in accordance with an aspect of the present disclosure;

FIG. 2B and FIG. 2C provide alternate side views of the platform of FIG. 2A, in accordance with an aspect of the present disclosure;

FIG. 2D provides a plan view of the platform of FIG. 2A, in accordance with an aspect of the present disclosure;

FIG. 3A provides a perspective view of a further alternate example embodiment of a platform in accordance with an aspect tethered to a bed of a body of water at an operating depth, in accordance with an aspect of the present disclosure;

FIG. 3B and FIG. 3C provide alternate side views of the platform of FIG. 3A, in accordance with an aspect of the present disclosure;

FIG. 3D provides a plan view of the platform of FIG. 3A, in accordance with an aspect of the present disclosure;

FIG. 4A provides a perspective view of a further alternate example embodiment of a platform in accordance with an aspect tethered to a bed of a body of water at an operating depth, in accordance with an aspect of the present disclosure;

FIG. 4B and FIG. 4C provide alternate side views of the platform of FIG. 4A, in accordance with an aspect of the present disclosure;

FIG. 4D provides a plan view of the platform of FIG. 4A, in accordance with an aspect of the present disclosure;

FIG. 5A provides a perspective view of a further alternate example embodiment of a platform in accordance with an aspect tethered to a bed of a body of water at an operating depth, in accordance with an aspect of the present disclosure;

FIG. 5B and FIG. 5C provide alternate side views of the platform of FIG. 5A, in accordance with an aspect of the present disclosure;

FIG. 5D provides a plan view of the platform of FIG. 5A, in accordance with an aspect of the present disclosure;

FIG. 6A provides a perspective view of an example embodiment of a platform in accordance with an aspect tethered to a bed of a body of water at an operating depth, in accordance with an aspect of the present disclosure;

FIG. 6B provides alternate side views of the platform of FIG. 6A, in accordance with an aspect of the present disclosure;

FIG. 7 provides an arrangement of a structural element according to one or more embodiments, in accordance with an aspect of the present disclosure; and

FIG. 8 provides a perspective view of an example embodiment of a platform in accordance with an aspect with a protection member on mooring lines, in accordance with an aspect of the present disclosure.

### DETAILED DESCRIPTION FOR CARRYING OUT THE INVENTION

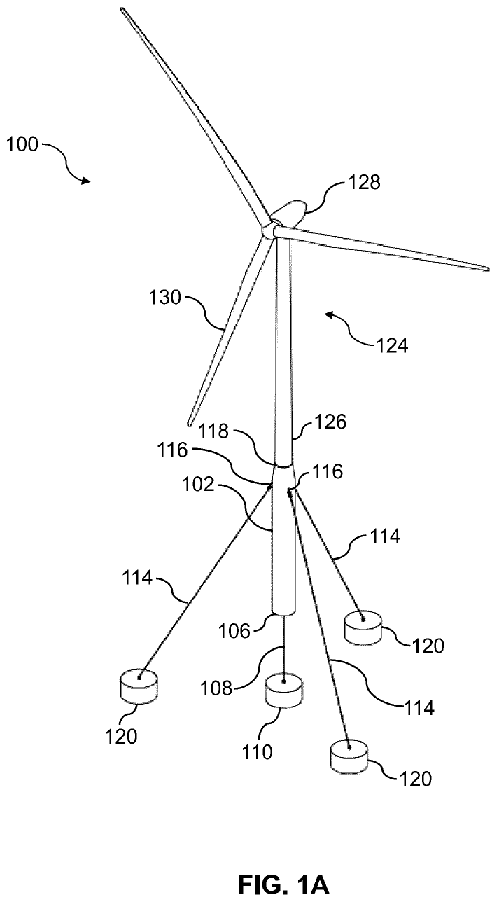

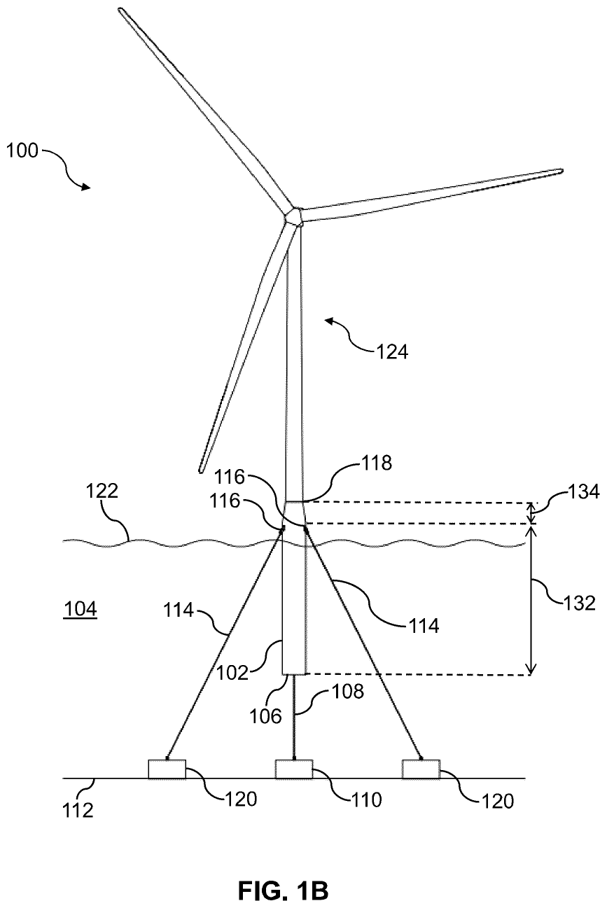

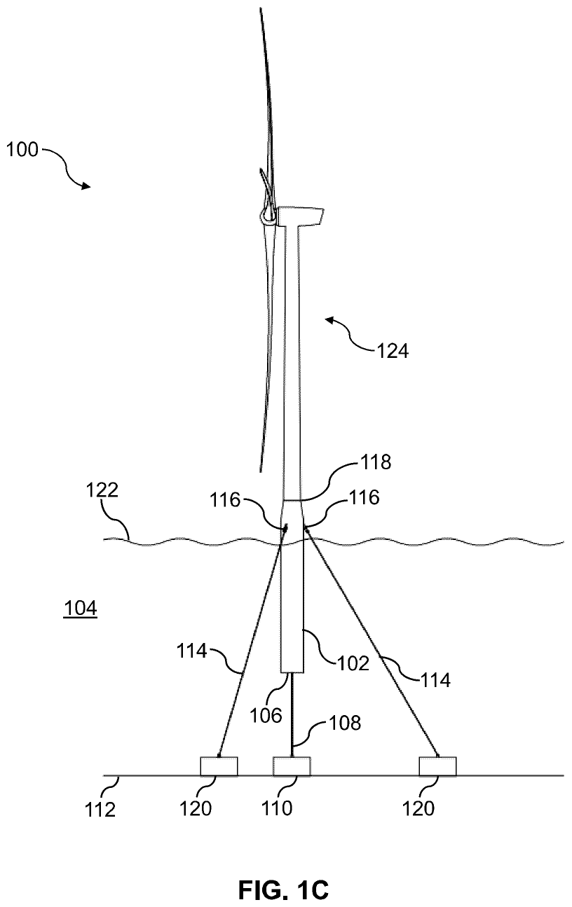

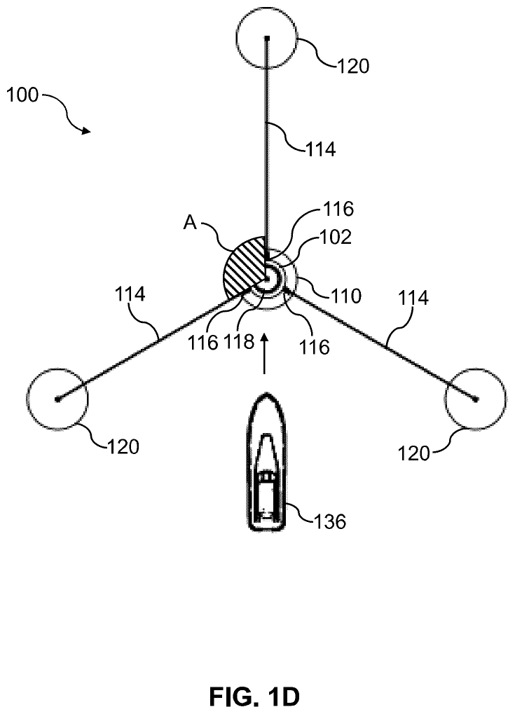

Referring to FIG. 1A, a perspective view of an example embodiment of a buoyant offshore platform 100 is shown in accordance with an aspect, the platform 100 being suitable for supporting a renewable energy system 124 mounted thereon. In the particular example described, the platform 100 comprises an elongate structural spar 102, the spar 102 being buoyant in a body of water 104. Extending from a bottom end 106 of the spar 102 is a first mooring line 108 affixed to a corresponding anchor point 110 at end thereof distal to the spar 102, thereby tethering the spar 102 to a bed 112 of the body of water 104. The length of the first mooring line 108 is such that the buoyant spar 102 is positioned partially submerged in the body of water 104 at an operating depth, as seen more clearly in the side views of FIG. 1B and FIG. 1C, at which a top end 118 of the spar 102 is maintained above a surface 122 of the body of water 104.

In the embodiment 100 shown, supported on a planar top surface 118 of the spar 102 and extending therefrom is a mast 126 of a wind turbine 124, the mast 126 extending substantially coaxially with the spar 102. Atop the mast 126 is supported a nacelle 128 of the wind turbine housing energy capturing machinery driven by the rotation of a rotor having a plurality of wind turbine rotor blades 130.

While the first mooring line 108 acts to stabilise the spar against vertical motion which may otherwise take place as a result of the action of, for example wave forces, on the spar 102, the action of wind forces on the wind turbine 124 causes an angular moment on the mast 126 which would ordinarily cause pitch and/or roll of the spar 102 in the body of water 104. Such movement of the spar 102 in the body of water 104 during operation of the wind turbine 124 could act to limit the operational efficiency of wind energy capture and conversion by the wind turbine 124. The platform 100 of the present invention comprises a plurality of further mooring lines 114 affixed at mooring line fixation points 116 near the top end 118 of the spar 102 and extending at an oblique/diagonal angle relative to the spar 102 toward corresponding further anchor points 120. The diagonal positioning of the further mooring lines 114, having their fixation points 116 positioned near the top end 118 of the spar 102 stabilises the spar 102 against any pitch and/or roll movements that may be caused by the action of wind and/or wave forces acting on the spar 102 or wind forces acting on the wind turbine 124. As such the spar 102, and by extension the wind turbine 124, are held substantially stationary in the body of water 104 such that optimal operating efficiency of the wind turbine 124 is maintained.

The corresponding further anchor points 120 are arranged on the bed 112 of the body of water 104 such that they form vertices of a triangle. In the particular embodiment shown, the platform 100 forms part of a larger farm of offshore floating wind turbines intended to capture wind energy from wind occurring in largely a single direction. As such the nacelle 128 of the example wind turbine 124 shown is of a fixed direction having the rotor blades 140 positioned in a plane perpendicular to a prevailing wind capture direction. To provide adequate stability of the spar 102 and the turbine 124 against the wind forces primarily acting in the single capture direction, one of the further anchor points 120 is positioned in a plane directly behind the nacelle 128 and substantially coplanar with the rotor thereof. In the embodiment shown, the anchor point 110 of the first mooring line 108 is positioned off-centre within the triangle formed by the further anchor points 120, such that the anchor point is positioned further from this rear further anchor point 120 than the other two laterally-positioned further anchor points 120. Embodiments will be appreciated wherein the first mooring line anchor point 110 is positioned centrally within the triangle formed by the further anchor points 120 of the further mooring lines 114, which may provide largely equal stability in all directions.

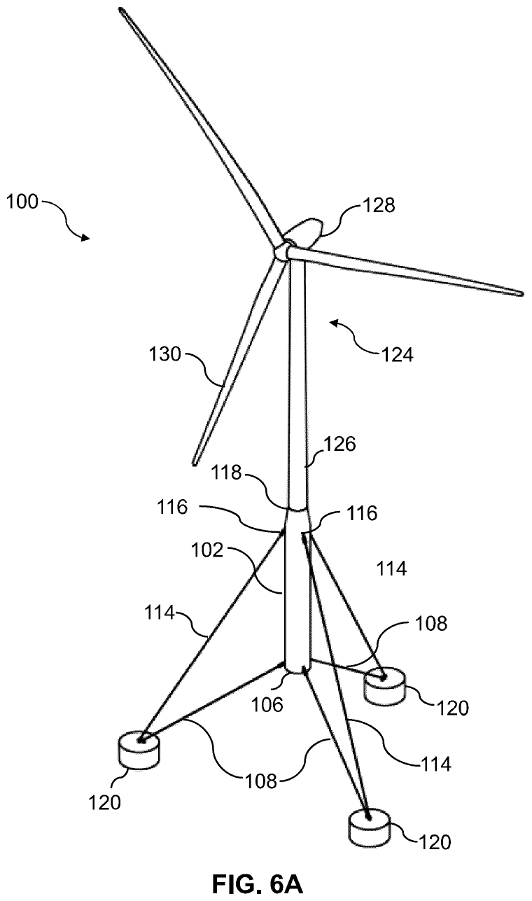

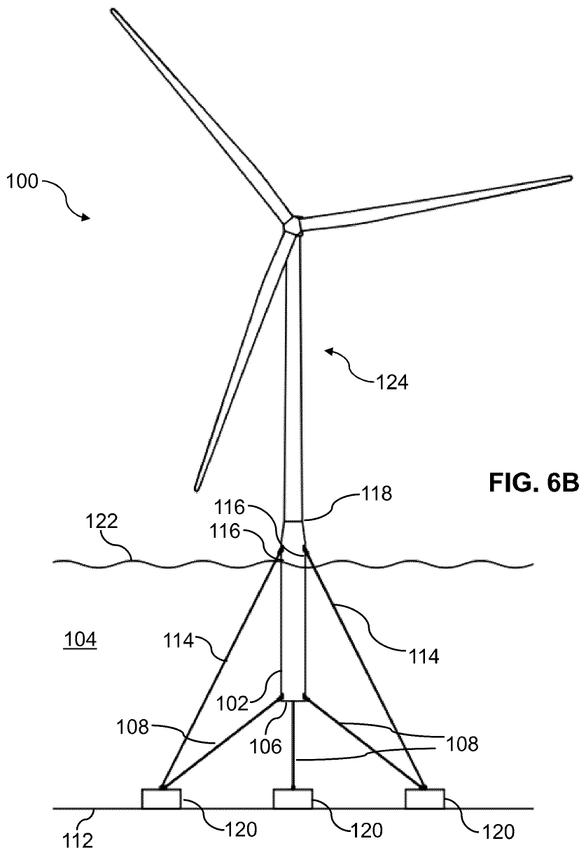

Referring to FIG. 6A, a perspective view of an alternative example embodiment of the mooring lines for a buoyant offshore platform 100 is shown in accordance with an aspect. As with FIG. 1A, the platform 100 being suitable for supporting a renewable energy system 124 mounted thereon. In the particular example described, the platform 100 comprises an elongate structural spar 102, the spar 102 being buoyant in a body of water 104. However, in FIG. 6A, three first mooring lines 108 extend from a bottom end 106 of the spar 102 each being affixed to a corresponding anchor point 120 shared with a corresponding one of the further mooring lines 114. Each of the three first mooring lines extend at an oblique/diagonal angle relative to the spar 102 toward the respective further anchor points 120. The length of the three first mooring lines 108 is such that the buoyant spar 102 is positioned partially submerged in the body of water 104 at an operating depth, as seen more clearly in the side view of FIG. 6B, at which a top end 118 of the spar 102 is maintained above a surface 122 of the body of water 104. The three first mooring lines 108 act to stabilise the spar against vertical motion which may otherwise take place as a result of the action of, for example wave forces, on the spar 102, the action of wind forces on the wind turbine 124 causes an angular moment on the mast 126 which would ordinarily cause pitch and/or roll of the spar 102 in the body of water 104. The anchor points 120 are arranged on the bed 112 of the body of water 104 in a similar manner to that described in relation to FIGS. 1A to 1C. As will be appreciated, there may be any number of first mooring lines and the arrangement of three first mooring lines shown in FIGS. 6A and 6B is an example only. It will also be appreciated that the arrangement of the first mooring line described in relation to FIGS. 1A to 1C may be combined with the arrangement of the plurality of first mooring lines described in relation to FIGS. 6A and 6B.

In example embodiments. the spar is an elongate spar wherein the elongate nature of the spar 102 inherently orients its smallest dimension (width) against counteracting wave forces, thereby minimising resultant drag and its effects on movement of the spar 102 during operation. The body of the spar 102 in the example embodiment shown is substantially cylindrical and thus the curved surface thereof provides hydrodynamic surface minimising drag against incident wave forces. The body of the spar 102 in the example shown comprises a lower portion 132 extending from the bottom end 106 of the spar toward a point along the spar proximate the top end 118, the lower point 132 having a constant diameter along its length. The body of the spar 102 further comprises an upper portion 134 extending from adjacent the lower portion 132 to the top end 118 of the spar 102, the upper portion 134 having a variable diameter across its length with the diameter adjacent the lower portion 134 being greater than the diameter forming the top end 118 of the spar 102. The greater volume of the lower portion 132 in the embodiment shown provides adequate internal volume for providing the required buoyancy of the spar 102. Embodiments will be appreciated wherein any elongate shape of the spar is provided.

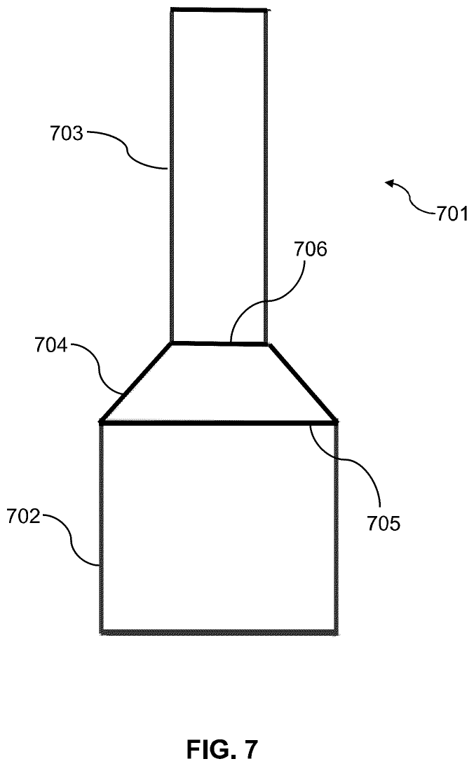

With reference to FIG. 7, there is shown an alternatively shaped spar 701, which will be referred to as a bottle-shaped spar. The body of the bottle-shaped spar 701 in the example shown comprises a first cylindrical section 702 (e.g. lower portion) with a first predetermined diameter that is substantially constant along the length of the first cylindrical section 702. The body of the bottle-shaped spar further comprises a second cylindrical section 703 (e.g. upper portion) with a second predetermined diameter that is substantially constant along the length of the second cylindrical section 703, wherein the second predetermined diameter is smaller than the first predetermined diameter. The body of the bottle-shaped spar 701 of the example shown in FIG. 7 further comprises a tapered section 704 (e.g. middle portion) located between, and joining, the first cylindrical section 702 and the second cylindrical section 703. Thus, in this example, the lower end 705 of the tapered section 704 has a diameter of the first predetermined diameter of the first cylindrical section 702 and the upper end 706 of the tapered section 704 has a diameter of the second predetermined diameter of the second cylindrical section 703. The diameter of the tapered section reduces along the length of the tapered section 704 from the first predetermined diameter to the second predetermined diameter. However, as will be appreciated, the bottle-shaped spar may comprise a flat section, rather than a tapered section, between the first cylindrical section 702 and the second cylindrical section 703. As with the elongate spar, the bottle-shaped spar 701 inherently orients its smallest dimension (width) against counteracting wave forces, thereby minimising resultant drag and its effects on movement of the spar 701 during operation. The body of the spar 701 in the example embodiment shown is substantially cylindrical and thus the curved surface thereof also provides hydrodynamic surface minimising drag against incident wave forces.

The fixation points 116 of the further mooring lines 114 in the embodiment shown in FIGS. 1A to 1D, 6A and 6B, are arranged on a common plane at a point along the length of the spar 102 near the top end 118 thereof. As shown in the plan view of the platform 100 depicted in FIG. 1D (shown absent the wind turbine 124 for simplicity), the fixation points 116 are located at corresponding locations about the circumference of the spar 102 such that an angle A subtended at the centre of the spar 102 by an arc defined between each adjacent pair of mooring line fixation points 116 is the same. In the example shown, the angle A is 120°. Therefore, in the embodiment shown, a distance along the circumference of the spar between each two mooring line fixation points 116 is the same. As such the spar in the example shown is equally accessible to a marine vessel 136 between any two mooring line fixation points 116. The elongate nature of the spar 102, having the wind turbine 124 supported thereon, maximises said accessibility for marine vessels 136, thereby improving the simplicity and safety of deploying a farm of said platforms 100 to a desired deployment region in the body of water 104, and ongoing maintenance of said platforms 100 and wind turbines 124. The sparse arrangement of the mooring line fixation points 116 about the circumference of the spar 102 in the example shown, and the resultant space between the mooring line fixation points 116 therefore provides a vessel access portion of the spar 102, providing a means for marine vessels 136 to approach the spar with minimal risk of collision of the marine vessel 136 hull with the mooring lines 114 or the fixation points 116.

In some instances, however, the approach of a marine vessel 136 may present too great a risk of collision with the spar 102 body, the mooring lines 114 or the corresponding fixation points 116.

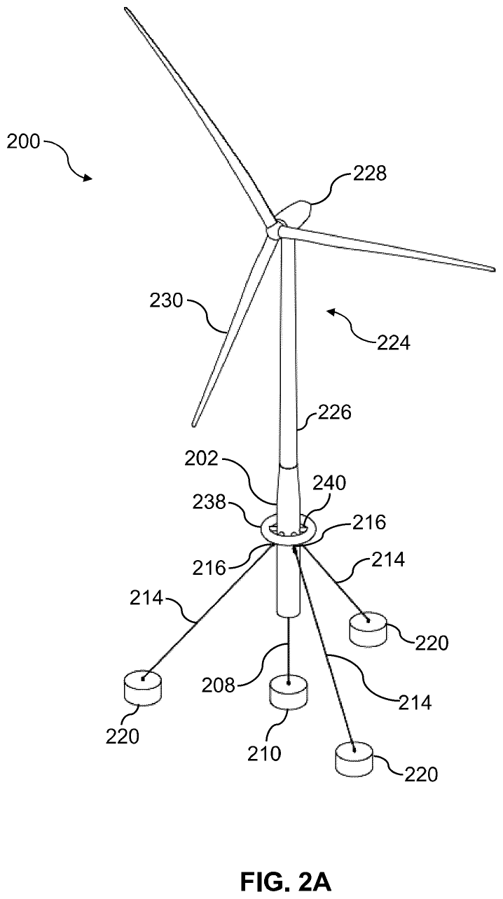

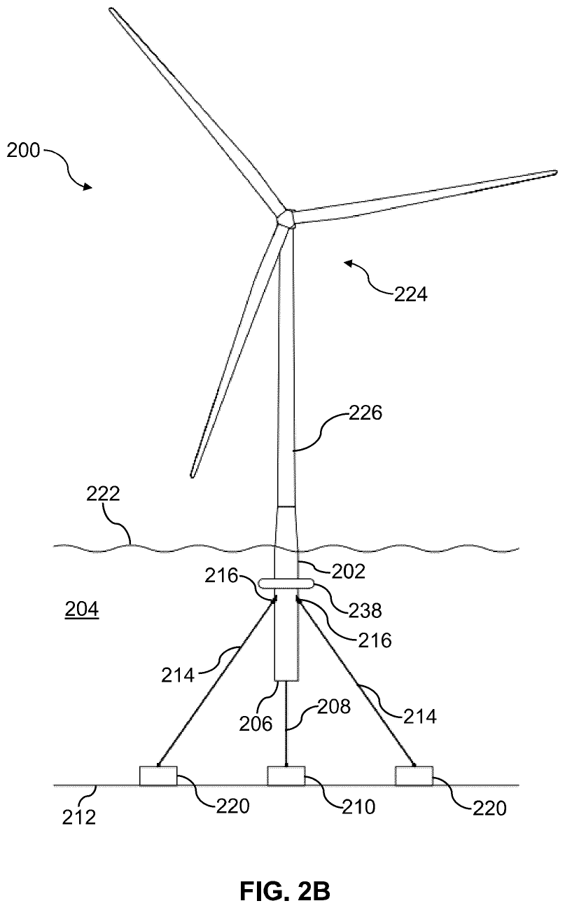

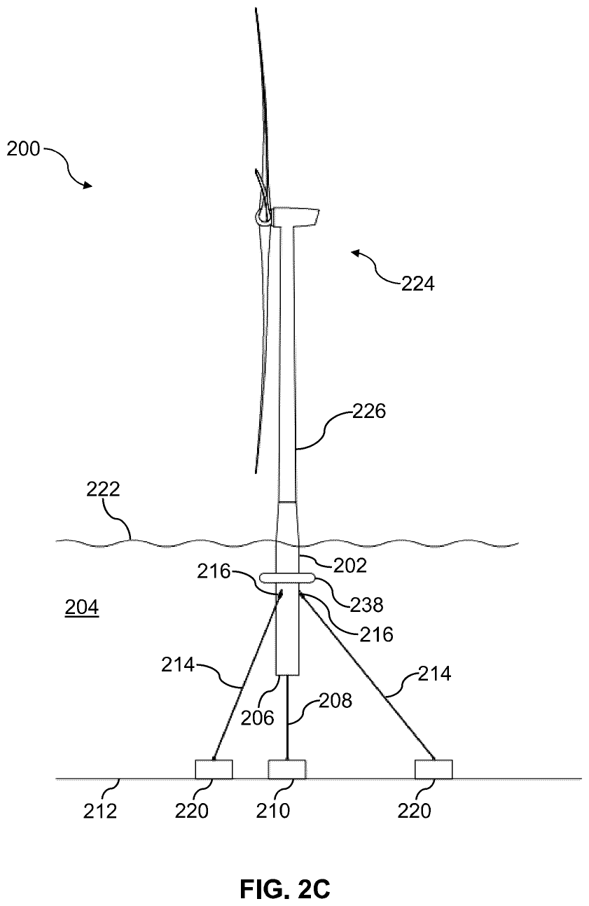

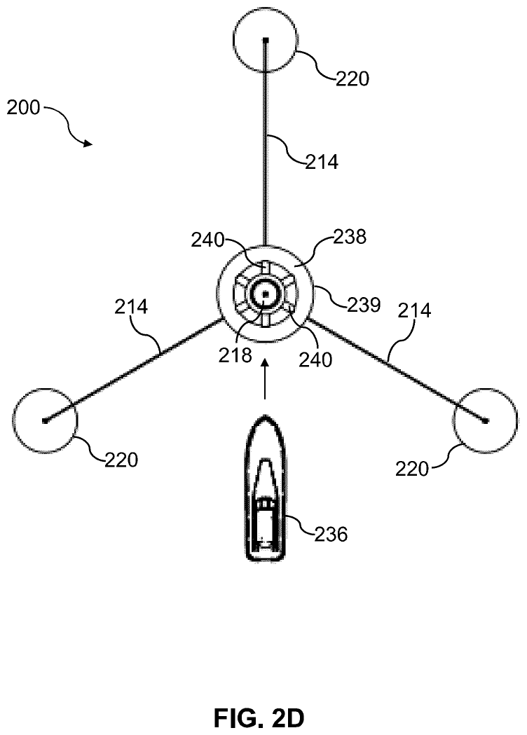

Shown in FIG. 2A to FIG. 2D is an alternate example embodiment 200 of a platform in accordance with the present invention comprising a bumper feature 238 intended to protect the spar body and/or the mooring lines and fixation points from collision with approaching marine vessels. The example embodiment 200 is largely the same as the embodiment 100 of FIG. 1A to FIG. 1D, and therefore the same numbering system is used for corresponding features to aid ease of understanding. For example spar 202 is substantially the same as spar 102, etc. As will be appreciated, the bumper feature may equally apply to the bottle-shaped spar shown in FIG. 7 and the mooring arrangement shown in FIGS. 6A and 6B.

Unlike the embodiment 100 of FIG. 1A to FIG. 1D, the alternate embodiment 200 additionally comprises a guard member 238 formed of a substantially toroidal body 238 extending about the circumference of the spar 202 and separated therefrom by a plurality of cylindrical brackets 240 extending between the guard member 238 and the outer surface of the spar 202. The guard member 238 comprises an outer shock-absorbing surface 239 intended for engagement with an approaching marine vessel 236 hull before the marine vessel 236 hull is able to reach the spar 202 body, such that the spar 202 body is protected from collision. In the example embodiment 200 shown, the guard member 238 extends about the circumference of the spar 202 at a point along the length of the spar 202 nearer the top end 218 thereof than the bottom end 206. In the example embodiment 200, the guard member 238 is positioned along the spar 202 body such that when the spar 202 is deployed to the operating depth shown in FIG. 2B and FIG. 2C, the guard member 238 is located beneath the surface 222 of the body of water 204. Also in the embodiment 200 shown, the mooring line fixation points 216 are positioned at substantially equivalent distances from one another in line with the embodiment 100 of FIG. 1A to FIG. 1D, but in the alternate embodiment 200 are positioned immediately beneath the guard member 238 such that at the operating depth, the mooring line fixation points 216 are also positioned below the surface 222 of the body of water 204. The positioning of the mooring line fixation points 216 below the guard member 238 as shown acts to further protect the mooring lines 214 and the corresponding fixation points 216 from collision and/or entanglement with the marine vessel 236 or associated rigging. As will be appreciated, the guard member feature(s) may equally apply to the bottle-shaped spar shown in FIG. 7 and the mooring arrangement shown in FIGS. 6A and 6B.

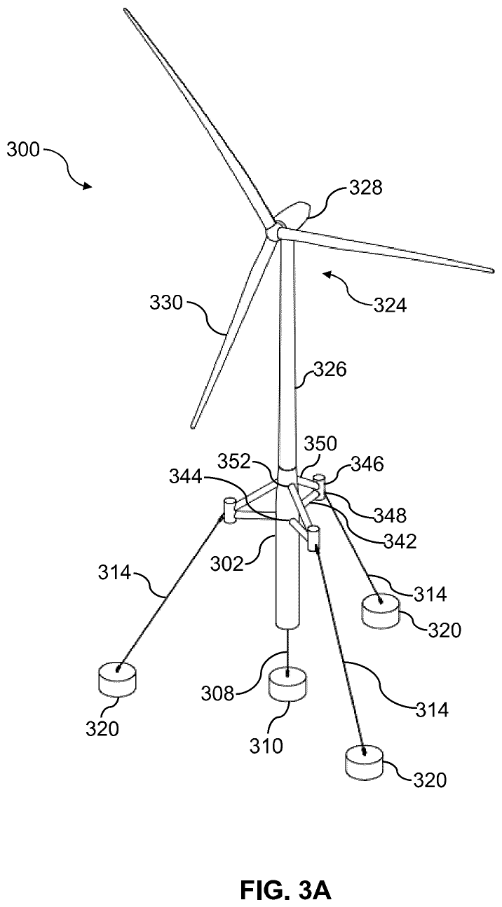

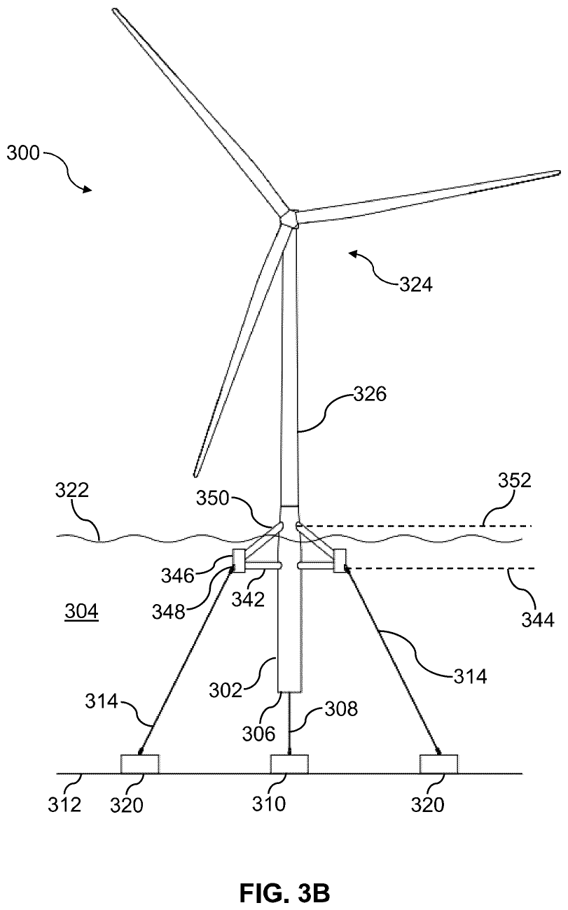

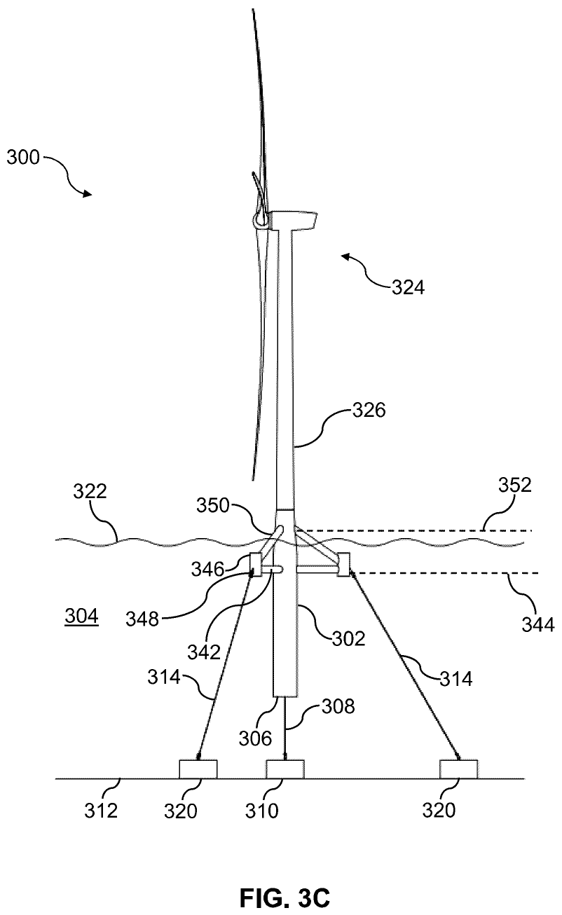

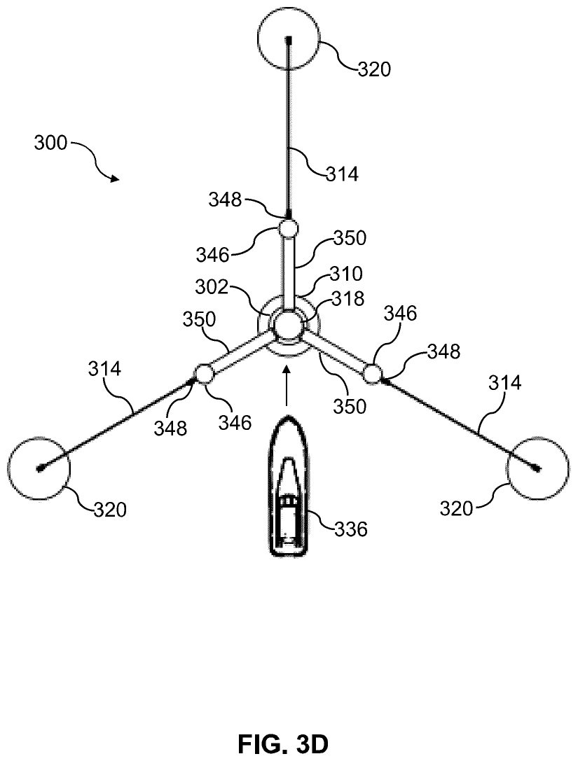

In some instances, however, the lowering of the mooring line fixation points 216 along the spar 202 body could act to reduce the stability of the upper end 218 of the spar 202 against angular moments acting thereon due to wave and wind forces. Shown in FIG. 3A to FIG. 3D is a further alternate example embodiment 300 of a platform in accordance with the present invention comprising outrigger members intended to define, for each actual mooring line fixation point, a corresponding effective mooring line fixation point, each effective mooring line fixation point positioned upwards on the spar body relative to the respective actual mooring line fixation point, thereby benefitting from the higher placement of the mooring line fixation point while potentially avoiding the risk of damage or entanglement which may occur with such embodiments as that of FIGS. 1A to 1D.

The example embodiment 300 is largely the same as the embodiment 100 of FIG. 1A to FIG. 1D, and therefore the same numbering system is used for corresponding features to aid ease of understanding. For example spar 302 is substantially the same as spar 102, etc.

Unlike the embodiment 100 of FIG. 1A to FIG. 1D, the further alternate embodiment 300 comprises, for each further mooring line 314, an outrigger member comprising an elongate cylindrical lateral brace 342 extending outwardly from a first point 344 on the spar 302 body to a distal body 346 supporting a mooring line fixation point 348 thereon. The mooring line fixation point 348 is therefore distanced laterally from the point 344 along the spar 302 body by the lateral brace 342 and the distal body 346. One of the further mooring lines 314 of the platform 300 is affixed in communication with the spar 302 body at the corresponding mooring line fixation point 348. The distal body 346 is further supported at its location distanced from the spar 302 body by way of a diagonal brace 350 extending from the distal body 346 to a second point 352 along the spar 302 body, the second point 352 located higher on the spar 302 body than the first point 344 of the lateral brace 342. The diagonal brace 350 thereby provides diagonal support to the distal body 346, and by extension to the mooring line fixation point 348, while providing a higher effective mooring line fixation point 352. As shown in the side views depicted in FIG. 3B and FIG. 3C, the effective mooring line fixation point 352 afforded by the point of engagement of the diagonal brace 350 with the spar 302 body, is higher than the actual mooring line fixation point 348 positioned on the distal body 346 and having engagement with the spar 302 body at the first point 344 by way of the lateral brace 342. In the particular embodiment shown, the second point 352 is located above the surface 322 of the body of water 304 when the platform 300 is positioned at the operating depth, and the mooring lines 314 are affixed to the distal body 346 below the surface 322 of the body of water 304.

As shown in FIG. 3D, the distancing of the mooring line fixation point 348 from the spar 302 body reduces the likelihood of engagement and entanglement with approach marine vessels 336.

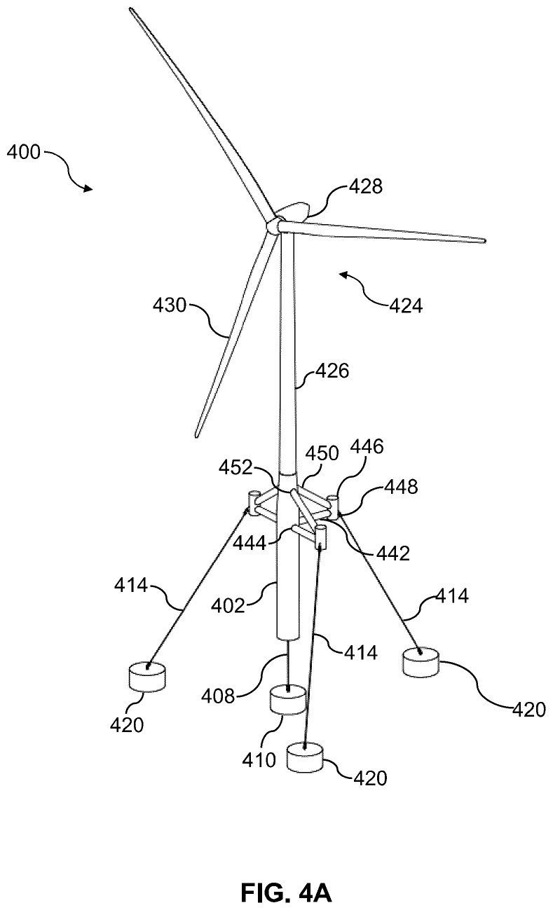

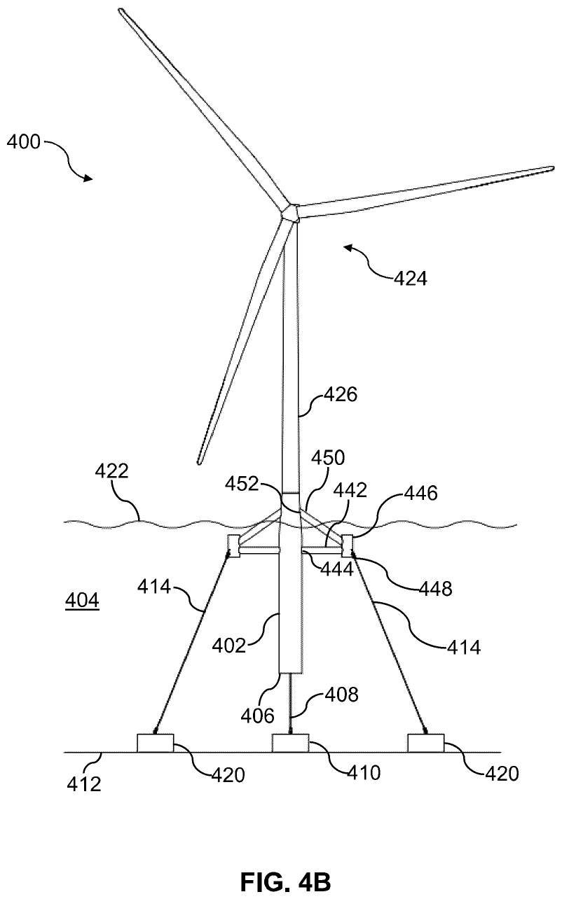

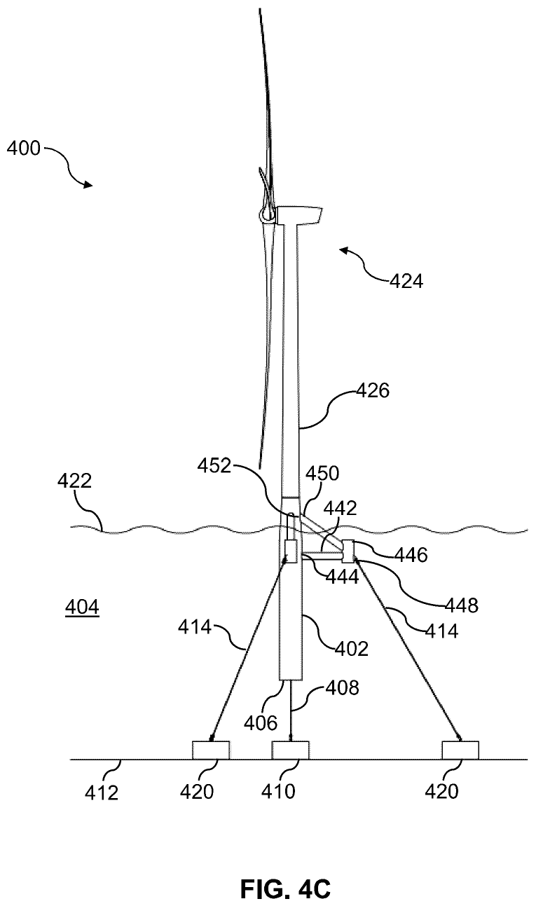

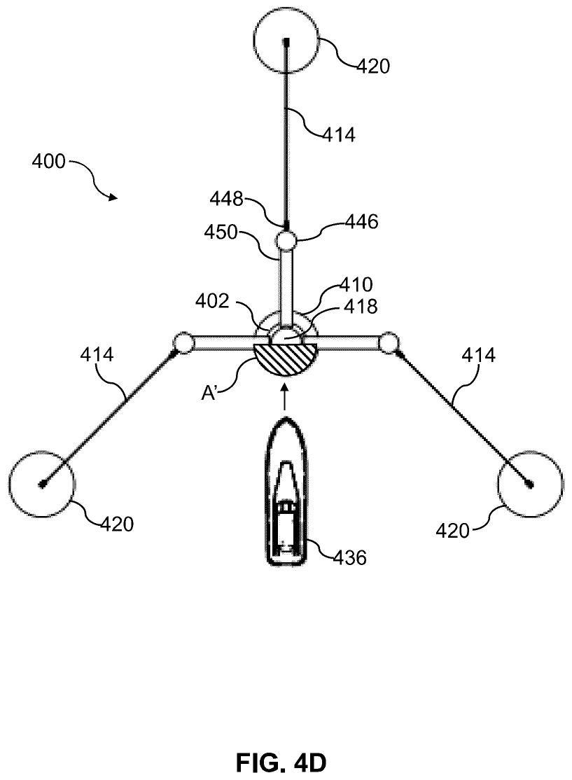

In some instances, however, the positioning of the outrigger members, while improving the stability of the upper end of the spar, may provide some risk of collision of a marine vessel with the outrigger members. Shown in FIG. 4A to FIG. 4D is a further alternate example embodiment 400 of a platform in accordance with the present invention comprising outrigger members which are positioned to provide a larger vessel access portion of the spar, intended to provide a lower risk of unwanted engagement with the spar body or the outrigger members by the marine vessel on approach-for example during deployment or maintenance. The example embodiment 400 is largely the same as the embodiment 100 of FIG. 1A to FIG. 1D, and therefore the same numbering system is used for corresponding features to aid ease of understanding. For example spar 402 is substantially the same as spar 102, etc.

The embodiment 400 of FIG. 4A to FIG. 4D comprises an outrigger member for each further mooring line 414 in line with the embodiment 300 of FIG. 3A to FIG. 3D. However, in the embodiment 400 of FIG. 4A to FIG. 4D, two said outrigger members extend from the spar 402 body in opposing directions and in the same plane, defining an angle A′ of 180° subtended by the arc defined therebetween, from the centre of the spar 402. The third said outrigger member in the embodiment 400 shown extends in a plane perpendicular to that of the two coplanar outrigger members. The positioning of the two coplanar outrigger members in this manner therefore provides a larger vessel access portion as shown in FIG. 4D, thereby minimising risk of unwanted collision of the vessel 436 with the outrigger members.

In the example embodiment 400 shown, the corresponding further anchor points 420 of the further mooring lines 414 are positioned such that the respective further mooring lines 414 extend along respective axes, wherein the respective axes do not intersect. Embodiments will be appreciated wherein the axes do intersect.

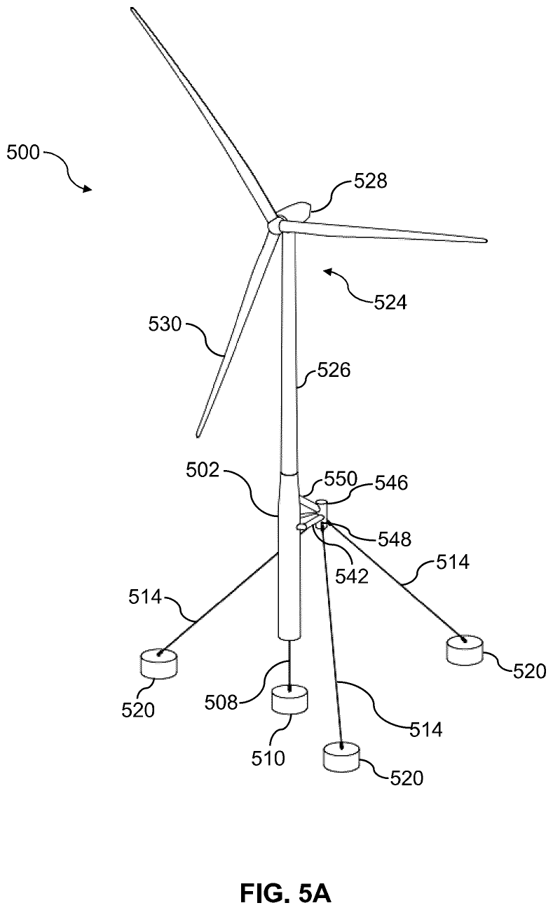

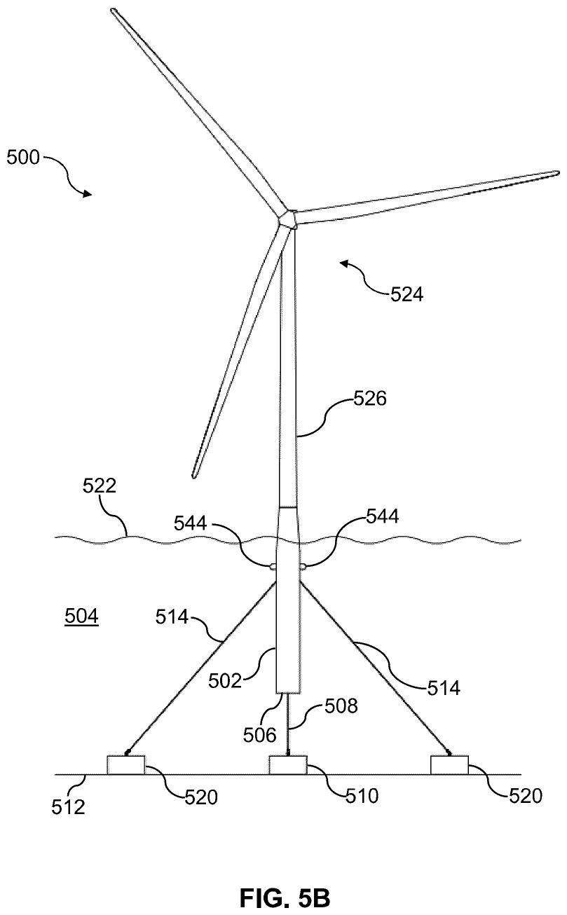

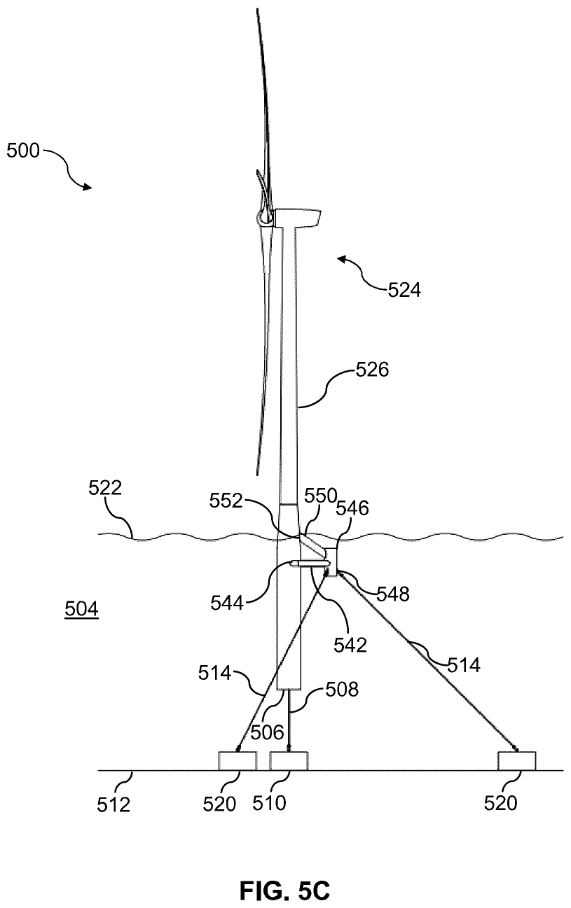

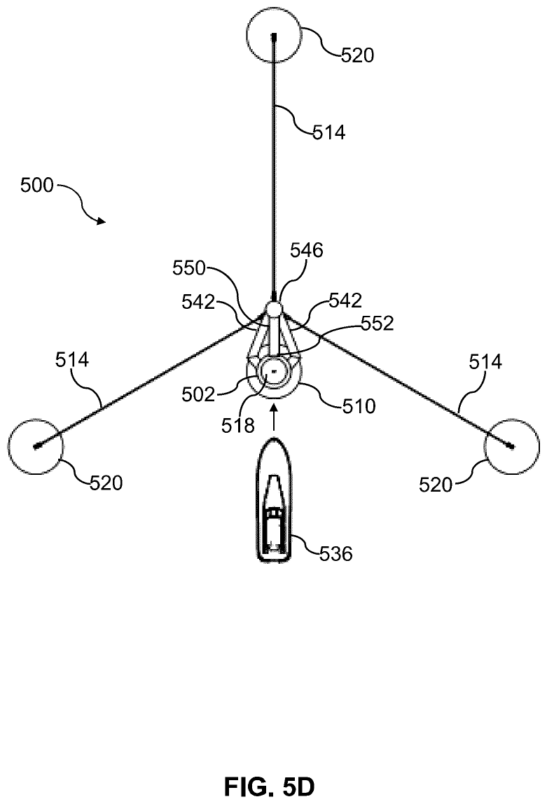

In some instances, it may be beneficial to provide access to larger marine vessels or a greater number of vessels. It may also be required to simplify the outrigger structure for the purposes of improving ease of assembly. In such embodiments, it may be beneficial to have a single outrigger member supporting mooring line fixation points for each of the further mooring lines. While the positioning of a single outrigger member in this manner may experience reduced stability of the spar against angular moments acting thereon in one or more directions, said stability being reduced in said directions relative to embodiments having multiple outrigger members such as those shown in FIG. 3A to FIG. 4D, the increased simplicity and/or ease of vessel access in some directions, however, may be suitable for project sites having largely mono-directional wind and/or waves, and therefore such solutions may be preferred. An example such solution is depicted in FIG. 5A to FIG. 5D, which shows a further alternate example embodiment 500 of a platform in accordance with the present invention comprising a single outrigger member providing mooring line fixation points for each of the further mooring lines. The example embodiment 500 is largely the same as the embodiment 100 of FIG. 1A to FIG. 1D, and therefore the same numbering system is used for corresponding features to aid ease of understanding. For example, spar 502 is substantially the same as spar 102, etc.

While the embodiment 500 provides an outrigger member to effectively raise the height of the mooring line fixation point on the spar 502 body relative to the actual mooring line fixation point 548, unlike the embodiments 300 and 400 of FIG. 3A to FIG. 4D, the platform 500 comprises only a single outrigger member which provides mooring line fixation points 548 for each of the further mooring lines 514. The outrigger member in the embodiment 500 shown comprises two coplanar lateral braces 542 extending from corresponding points 544 on the spar 502 body outwardly to support a distal body 546. The mooring line fixation points 548 are located within a common plane on the distal body 546 and at respective locations about the outer surface of the distal body 548 such that an angle of approximately 120° is subtended from the centre of the distal body by an arc defined between two said mooring line fixation points 548. Each of the mooring lines 514 is therefore in communication with the spar 502 by way of the single outrigger member. As will be appreciated, the outrigger member feature(s) may equally apply to the bottle-shaped spar shown in FIG. 7 and to the mooring arrangement shown in FIGS. 6A and 6B.

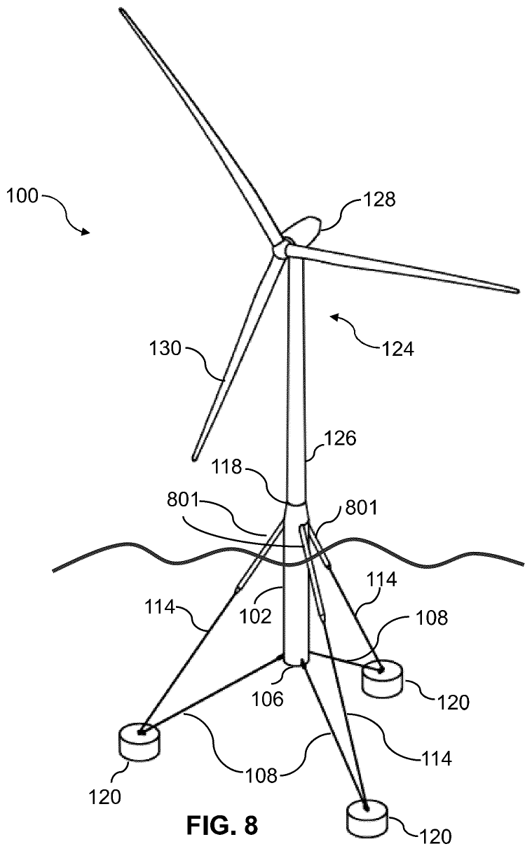

Referring to FIG. 8, one or more of the further mooring lines may further comprise a protection member 801, the protection member 801 extending from the first end of the further mooring lines 114 for a predetermined distance along the further mooring lines 114. In some embodiments, the protection member 801 is preferably either: an outer layer surrounding the further mooring line, or a substantially solid member to which the respective further mooring line is attached. The protection member 801 may be added to one or more of the further mooring lines 114 between the platform and a predetermined distance therefrom, wherein the predetermined distance may be based on a calculated depth below the mean waterline of the body of water. The protection member 801 may be an armoured outer layer applied to the further mooring line 114 or may be a solid section to which the further mooring line 114 is attached. As such, the protection member 801 may act to prevent damage to the further mooring lines 114, for example, through impacts with floating marine debris or accidental vessel contact.

It will be appreciated that the above-described embodiments are given as examples only and that alternatives are also considered within the scope of the disclosure. For example, the renewable energy system described in the example embodiments is a wind turbine, but embodiments will be appreciated wherein the renewable energy system is any suitable renewable energy conversion and/or storage device or system. In the foregoing embodiments, features described in relation to one embodiment or example may be combined, in any manner, with features of a different embodiment.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has”, and “having”), “include” (and any form of include, such as “includes” and “including”), and “contain” (and any form of contain, such as “contains” and “containing”) are open-ended linking verbs. As a result, a method or the buoyant platform that “comprises,” “has,” “includes,” or “contains” one or more steps or elements possesses those one or more steps or elements, but is not limited to possessing only those one or more steps or elements. Likewise, a step of a method or an element of the buoyant platform device that “comprises,” “has,” “includes,” or “contains” one or more features possesses those one or more features, but is not limited to possessing only those one or more features. Furthermore, the buoyant platform or structure that is configured in a certain way is configured in at least that way, but may also be configured in ways that are not listed.

The disclosure has been described with reference to the preferred embodiments. It will be understood that the architectural and operational embodiments described herein are exemplary of a plurality of possible arrangements to provide the same general features, characteristics, and general system operation. Modifications and alterations will occur to others upon a reading and understanding of the preceding detailed description. It is intended that the disclosure be construed as including all such modifications and alterations.

What is claimed is:

1. A buoyant offshore renewable energy system mounting platform, the platform comprising:
a buoyant spar having a top end and a bottom end, the spar arranged to support a renewable energy system thereon; and
a plurality of mooring lines arranged to tether the spar to a bed of a body of water such that the spar is positioned in the body of water at an operating depth, the plurality of mooring lines comprising:
one or more first mooring lines affixed to a bottom end of the spar, the bottom end distal to the top end, and arranged to engage the bed of the body of water; and
at least three further mooring lines, a first end of each of the further mooring lines being in communication with the spar between the top end and the bottom end thereof, and a second end of each further mooring line being arranged to engage the bed of the body of water such that said further mooring line is oriented diagonally relative to the spar at the operating depth;
wherein at the operating depth, the first end of the spar is positioned above a surface of the body of water, and the second end is positioned below the surface of the body of water.

2. The platform of claim 1, wherein the one or more first mooring lines are arranged to engage the bed of the body of water at a location vertically below the bottom end such that the first mooring line is substantially coaxial with the spar at the operating depth.

3. The platform of claim 1, wherein the one or more first mooring lines includes at least two first mooring lines being arranged to engage the bed of the body of water such that said at least two first mooring lines are oriented diagonally relative to the spar at the operating depth.

4. The platform of claim 1, wherein the spar is a buoyant elongate spar.

5. The platform of claim 1, wherein the spar is a buoyant spar having a first cylindrical section with a first predetermined diameter, a second cylindrical section with a second predetermined diameter, wherein the second predetermined diameter is smaller than the first predetermined diameter, and a tapered section between the first cylindrical section and the second cylindrical section.

6. The platform of claim 1, wherein a non-zero vertical spacing is defined between a mooring line fixation point of each of the one or more first mooring lines on the spar, and each of a respective mooring line fixation point of the further mooring lines.

7. The platform of claim 1, wherein at the operating depth, a buoyancy of the spar is arranged to apply a tension to the one or more first mooring lines and the further mooring lines;
said buoyancy being further arranged to support a mass of said renewable energy system such that the renewable energy system is maintained above a bed of the body of water.

8. The platform of claim 1, wherein the further mooring lines are each affixed to the spar at a respective location; and wherein at the operating depth, is at least one of:
each said respective location is above the surface of the body of water; or
each said respective location is below the surface of the body of water.

9. The platform of claim 8, wherein the spar further comprises a guard member, the guard member having an impact absorbing surface positioned at a guard member location located along a side wall of the spar between the top end and the bottom end.

10. The platform of claim 9, wherein one or more of:
i. the impact absorbing surface is supported at a non-zero distance from a side wall of the spar;
ii. the guard member extends at least partially about the periphery of the spar at the guard member location;
iii. the guard member is substantially toroidal, or a segmented toroid in shape;
iv. the guard member location is located at or above said respective locations.

11. The platform of claim 1, wherein the platform further comprises an outrigger member affixed to, and projecting outwardly from, an outrigger member location located along a side wall of the spar between the top end and the bottom end;
wherein the outrigger member comprises a mooring line fixation point located on a portion of the outrigger member distal to the spar; and
wherein the first end of at least one of the further mooring lines is affixed to the mooring line fixation point.

12. The platform of claim 11, wherein at least one of:
the first end of each of the further mooring lines is affixed to the mooring line fixation point; or
the platform comprises a corresponding said outrigger member for each of the further mooring lines, the first end of each said further mooring line being affixed to the mooring line fixation point of the corresponding outrigger member.

13. The platform of claim 11, wherein the outrigger member is arranged to support the mooring line fixation point at a non-zero distance from the spar.

14. The platform of claim 11, wherein the outrigger member comprises:
a lateral brace extending between a first point along a side wall of the spar and the mooring line fixation point in a direction substantially perpendicular to the spar; and
a diagonal brace extending between a second point along the side wall of the spar and the mooring line fixation point, the second point higher than the first point.

15. The platform of claim 11, wherein at the operating depth the further mooring lines are each oriented diagonally relative to the spar along a corresponding axis, wherein said corresponding axes do not intersect.

16. The platform of claim 11, wherein at the operating depth, the mooring line fixation point is positioned beneath the surface of the body of water.

17. The platform of claim 1, wherein the second end of each of the further mooring lines is tethered to a corresponding anchor point on the bed of the body of water, each said anchor point spaced to form vertices of a triangle on the bed of the body of water.

18. The platform of claim 1, wherein the spar comprises a vessel access portion, the vessel access portion being a portion of a side wall of the spar defined between two said mooring line fixation points or outrigger members.

19. The platform of claim 1, wherein the spar is substantially cylindrical.

20. The platform of claim 19, wherein the cylinder is tapered proximate the top end such that the diameter of the top end is smaller than the diameter of the bottom end.

21. The platform of claim 1, wherein the renewable energy system is a wind turbine.

22. The platform of claim 21, wherein the top end of the spar is arranged to support the wind turbine such that a mast thereof is substantially coaxial with the spar.

23. The platform of claim 1, wherein one or more of the further mooring lines includes a protection member, the protection member extending from the first end of the further mooring lines for a predetermined distance along the further mooring lines.

24. The platform of claim 23, wherein the protection member is either:
an outer layer surrounding the further mooring line; or
a substantially solid member to which the further mooring line is attached.
